(19) United States
(12) Patent Application Publication
(10) Pub. No.: US 2004/0180565 A1
(43) Pub. Date: Sep. 16, 2004

(54) Cable form connector with a circumferential seal

(76) Inventor: Peter Zweigle, Ditzingen (DE)

Correspondence Address: Richard L Mayer, Kenyon & Kenyon, One Broadway, New York, NY, 10004, US

(21) Appl. No.: 10/482,991

(22) PCT Filed: Jul. 5, 2002
(86) PCT No.: PCT/DE02/02461

(30) Foreign Application Priority Data
Jul. 7, 2001 (DE) 201 11 339.2

(51) Int. Cl. H01R 13/52

(52) U.S. Cl. 439/271

(57) ABSTRACT

The present invention relates to a wiring harness plug (1) for producing an electrical plug connection with a mating connector (2), made of a housing and a terminal strip (4) protruding at least in part from the housing (3) having contact elements as well as a seal (6) for sealing the electrical plug connection.

The present invention stands out in that the seal (6), in the region of the transition (5) between the housing (3) and the terminal strip (4), is positioned at least partially circumferentially around the wiring harness plug 1, and on its contact surface (8), pointing towards the mating connector (2), has crosspieces (9). The crosspieces (9) are developed perpendicular to the circumferential direction of the seal (6), the seal (6) itself having at least one cavity (10). It may be provided in addition that the cavity (10) is developed having a core (11), for example, to increase the Shore hardness.

The present invention relates to a wiring harness plug for producing an electrical plug connection, having a mating connector made up of a housing and a terminal strip protruding at least partially from the housing having contact elements as well as having a seal for sealing the electrical plug connection.

### BACKGROUND INFORMATION

Seals of the preceding type are used in electrical plug connections in order to seal the connection between the wiring harness plug and a mating connector. As a rule, radial seals are used for this which have good sealing properties per se. In order to compensate for a possible play compensation between the wiring harness plug and the mating connector, the radial seals are, in addition, braced axially.

### DISADVANTAGES OF THE RELATED ART

Because of the use of radial seals, the plugging forces, which have to be used for bringing about an electrical plug connection, are very high. In addition, the use of radial seals leads to undesired restrictions in the shaping of the sealing region.

### OBJECT OF THE PRESENT INVENTION

It is the object of the present invention to create a seal for an electrical plug connection that avoids the disadvantages of the related art.

### ATTAINMENT OF THE OBJECT

The object is attained in that, in the region of the transition between the housing and the terminal strip, the seal is positioned at least partially to surround the wiring harness plug, and has crosspieces, on its contact surface that points to the mating plug, which are formed perpendicular to the direction of the surrounding of the seal, the seal itself having at least one cavity.

### SUMMARY OF THE INVENTION

The seal itself is advantageously arranged about the entire circumference of the wiring harness plug and has a contact surface which cooperates with an edge formed by the mating plug. In this context, the contact surface lies on top of the edge.

Provided tolerances or even play between the wiring harness plug and the mating plug are present, this is compensated for by the seal.

In addition, the seal has crosspieces on its contact surface which preferably extend perpendicularly to the direction of the surrounding of the seal. Because of that, one avoids a planar contact on the edge, which brings with it the advantage that tolerances are thereby compensated for, since in the plugged-in state the seal arches like a diaphragm, and thus the outer ends enclose the edge of the mating plug.

Depending on the required Shore hardness of the seal, the cavities that are positioned in the seal are filled with a plastic substance or a rubber substance or cores.

Additional advantageous embodiments of the present invention become apparent from the following description, the claims and the drawings.

### BRIEF DESCRIPTION OF THE DRAWINGS

The figures show:

FIG. 1 a side view of a wiring harness plug, together with a mating plug, partially in section;

FIG. 2 a front view of the wiring harness plug according to FIG. 1 but without the mating plug;

FIG. 3 a partial view of the seal shown in FIG. 2, in the unplugged state;

FIG. 4 a partial view of the seal shown in FIG. 2, in the plugged-in state;

FIG. 5 a partial view of a further embodiment of the seal shown in FIG. 2;

FIG. 6 a section through the seal according to FIG. 5, along a line VI-VI;

FIG. 7 a partial view of a third embodiment of the seal shown in FIG. 2.

### DESCRIPTION OF THE EXEMPLARY EMBODIMENTS

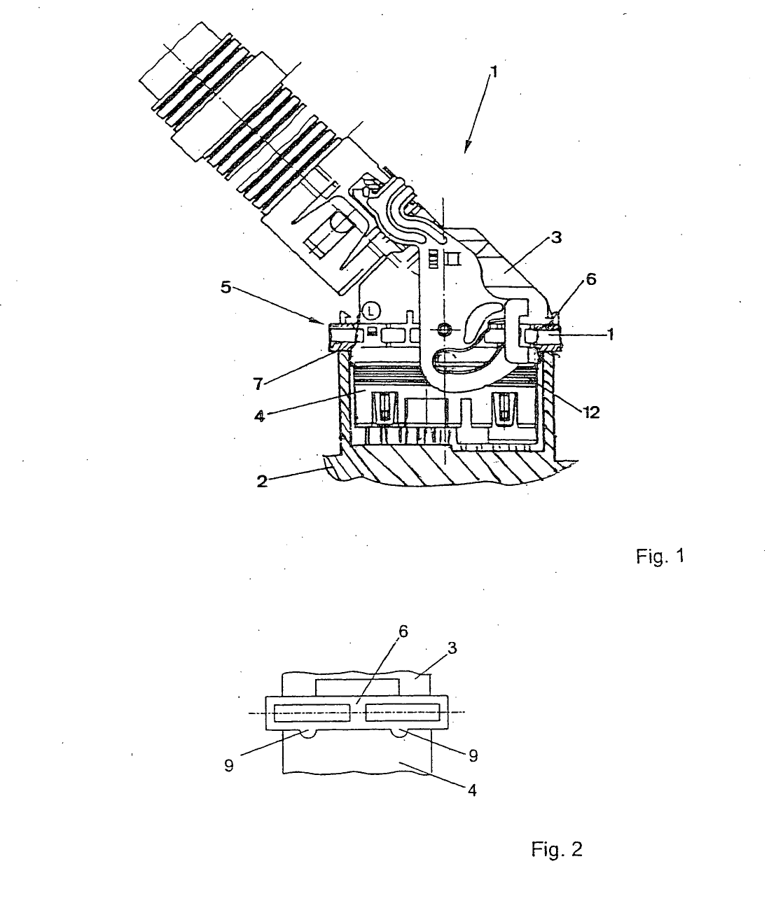

FIG. 1 shows a wiring harness plug 1 in a coupled state with a mating plug 2. Wiring harness plug 1 is made up of a housing 3 and a terminal strip 4 protruding a least partially from housing 3. In the coupled state, terminal strip 4 is almost completely introduced into mating plug 2.

In the region of transition 5 between housing 3 and terminal strip 4 there is a seal 6. In the exemplary embodiment shown in FIGS. 1-4, seal 6 runs completely around the circumference of wiring harness plug 1, and, in the coupled state, it lies on an outer edge 7 of mating plug 2, and thus seals the plug connection. Consequently, seal 6 is developed as an axial seal, and therefore has a contact surface 8 which cooperates with edge 7 of mating plug 2. For assembly, seal 6 may be pulled up over terminal strip 4, in the direction of housing 3 of wiring harness plug 1.

In addition, seal 6 has crosspieces 9 on its contact surface 8, which extend perpendicularly to the surrounding direction of seal 6. In the region of these crosspieces 9, cavities 10 are provided inside seal 6.

Furthermore, in FIG. 1, a radial seal 12 is situated.

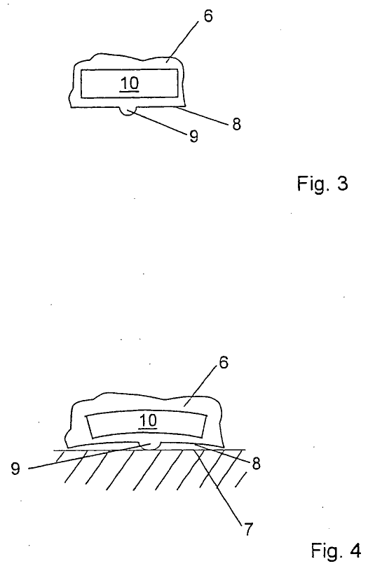

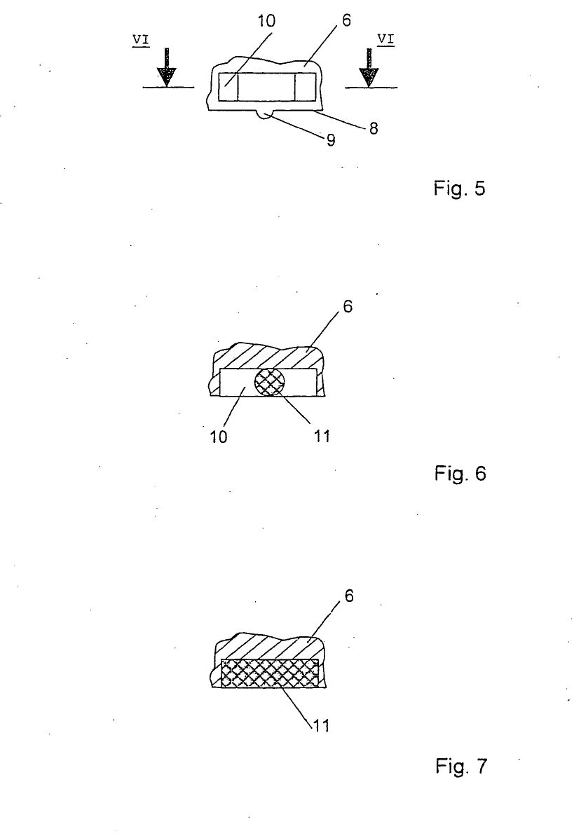

As shown in FIGS. 3 and 4, contact surface 8 of seal 6 arches like a diaphragm because seal 6 is set upon edge 7, so that sealing of the electrical plug connection takes place almost in every coupling position of wiring harness plug 1.

Alternatively to the specific embodiments of seal 6 described up to this point, it may be provided that within cavity 10 there is a core 11 having an identical or a different Shore hardness. In addition, it is conceivable, as shown in FIG. 7, that core 11 takes up the entire cavity 10 of seal 6.

It may further be provided that one develop seal 6 and core 11, situated in cavity 10, to have different Shore hardnesses.

What is claimed is:

1. A wiring harness plug 1 for producing an electrical plug connection with a mating connector, made of a housing and a terminal strip protruding at least in part from the housing having contact elements as well as a seal for sealing the electrical plug connection, wherein the seal (6) in the region of the transition (5) between the housing (3) and the terminal strip (4) is positioned at least partially circumferentially around the wiring harness plug (1), and on its contact surface (8), pointing towards the mating connector, has crosspieces (9) which are developed perpendicular to the circumferential direction of the seal (6), the seal (6) itself having at least one cavity (10).

2. The wiring harness plug as recited in claim 1, wherein in each case a cavity (10) is situated above the crosspiece (9).

3. The wiring harness plug as recited in claim 1 or 2, wherein the cavity (10) is at least partially filled by a core (11).

4. The wiring harness plug as recited in at least one of the preceding claims, wherein the core (11) is made of rubber.

5. The wiring harness plug as recited in claim 3 or 4, wherein the seal (6) and the core (11) have identical Shore values.

6. The wiring harness plug as recited in claim 3 or 4, wherein the seal (6) and the core (11) have different Shore values.
